(19) United States
(12) Patent Application Publication
(10) Pub. No.: US 2024/0304882 A1
(43) Pub. Date: Sep. 12, 2024

(54) DIRECT REGENERATION OF SPENT LITHIUM ELECTRODES VIA HEAT TREATMENT

(71) Applicants: 24M Technologies, Inc., Cambridge, MA (US); National Science and Technology Development Agency, Pathum Thani (TH); Global Power Synergy Public Company Limited, Bangkok (TH)

(72) Inventors: Nattanai KUNANUSONT, Bangkok (TH); Pimpa LIMTHONGKUL, Bangkok (TH); Junzheng CHEN, Concord, MA (US); Phontip TAMMAWAT, Rayong (TH); Thanathon SESUK, Pathum Thani (TH); Sunisa BUAKEAW, Loei (TH); Priew EIAMLAMAI, Phitsanulok (TH)

(21) Appl. No.: 18/596,235

(22) Filed: Mar. 5, 2024

Related U.S. Application Data
(60) Provisional application No. 63/450,488, filed on Mar. 7, 2023.

(51) Int. Cl. H01M 10/54; C01D 15/02; H01M 4/485

(52) U.S. Cl. CPC H01M 10/54; C01D 15/02; H01M 4/485; C01P 2006/40

(57) ABSTRACT

Embodiments described herein relate to regeneration of lithium-deficient electrodes (e.g., lithium iron phosphate, LFP). The process includes multiple steps of heat treatment. The first step includes mixing spent electrode material with lithium carbonate. The lithium carbonate and the spent LFP are then subject to a heating process in an all-nitrogen environment. The first heat treatment brings the materials up to about 550° C. to remove excess water and oxygen. The second heat treatment brings the materials up to about 1,000° C., where they are sintered together to form a like-new electrode material.

### CROSS-REFERENCE TO RELATED APPLICATIONS

The present application claims priority to, and benefit of U.S. Provisional Application No. 63/450,488, filed Mar. 7, 2023, and entitled “Direct Relithiation of Spent Lithium Electrodes via Heat Treatment,” the entire disclosure of which is incorporated herein by reference.

### TECHNICAL FIELD

Embodiments described herein relate generally to the remediation of electrochemical cell electrodes, and more specifically to methods and/or processes to regenerate depleted electrode materials.

### BACKGROUND

Batteries are typically constructed of solid electrodes, separators, electrolyte, and ancillary components, for example related to packaging, thermal management, cell balancing, consolidation of electrical current carriers into terminals, and/or other such components. Batteries can experience performance degradation over the course of their service life due unwanted chemical and/or physical processes that deplete and/or cause disconnection/degradation of active materials included in the battery's electrodes. Some known methods for recycling and/or refurbishing battery electrode materials involve high-temperature chemical (e.g., acid) based dissolution of electrode materials, and/or immersion of electrode coatings in molten salt baths at very high temperatures (e.g., 450° C. or higher). Other approaches have involved the dissolution/leaching of electrode materials in strong acids. The use of harsh chemical treatments is necessary due to the difficulty of mechanically separating electrode components in a conventional electrode coating due both to the presence of large amounts of binder materials and also due to the hardness and density of the coating after the mechanical calendaring process. Still other approaches have involved electrolysis-based recovery of metals, requiring high power consumption and large investments in equipment, while resulting in large quantities of unrecovered electrode components

Such methods have been found to cause damage to/erosion of the underlying current collector, and subsequent recovery of the coating constituents (e.g., electrode active material(s), conductive additive(s), and/or electrolyte salt(s)) from the molten salt bath has been found to be uneconomical. Furthermore, refurbishment and/or recycling of electrode active material(s) recovered from electrodes experiencing performance degradation can be difficult due to loss of one or more component caused by unwanted irreversible side reactions occurring during normal operation of the battery or electrochemical cell. Consequently, improved methods of remediating electrochemical cell electrodes are economically and environmentally desirable.

### SUMMARY

Embodiments described herein relate to the remediation of electrochemical cells via heat treatment. In some aspects a method for regeneration of an electrode active material included in a depleted electrode material can include obtaining an electrode active material, mixing an additive with the electrode active material to produce a replenished electrode active material, homogenizing the replenished electrode active material, and exposing the replenished electrode active material to a heat process including heating the replenished electrode active material to a first temperature, flowing a gas stream, and holding the replenished electrode active material at the first temperature for a first period of time, heating the replenished electrode active material to a second temperature, flowing the gas stream, and holding the replenished electrode active material at the second temperature for a second period of time, and cooling the replenished electrode active material from the second temperature to ambient temperature flowing the gas stream.

In some embodiments, a method includes: mixing one or more additives with a used electrode active material to produce a replenished electrode active material; heating the replenished electrode active material to a first temperature while exposed to a first gas; holding the replenished electrode active material at the first temperature for a first period of time; heating the replenished electrode active material to a second temperature while exposed to a second gas; holding the replenished electrode active material at the second temperature for a second period of time; and cooling the replenished electrode active material from the second temperature to ambient temperature while exposed to the second gas.

In some embodiments, a method for replenishing an electrode active material included in a depleted electrode material includes: mixing an additive with the electrode active material to produce a mixture; exposing the mixture to a gas flow for a first period of time at ambient temperature; heating the mixture to a replenishing temperature while exposed to the gas flow; holding the mixture at the replenishing temperature for a second period of time while exposed to the gas flow; and cooling the mixture to the ambient temperature while exposed to the gas flow to obtain a replenished electrode active material.

### BRIEF DESCRIPTION OF THE DRAWINGS

FIG. 1 is a schematic illustration of a heat treatment process for the relithiation of an electrode material, according to an embodiment.

FIG. 2 is a flow diagram a process for the relithiation of an electrode active material, according to an embodiment.

### DETAILED DESCRIPTION

Rechargeable batteries, such as lithium-ion batteries, can exhibit capacity loss or “capacity fade” over the course of their service life. Capacity fade manifests as the reduced ability of the battery to deliver charge at the rated voltage. Capacity fade can occur due to a loss of cyclable lithium and/or electrical disconnection of active materials. In a lithium-ion battery, the full lithium inventory of the cell is provided by the positive electrode (“cathode”) active material. Lithium can be lost by consumption in irreversible side reactions within a lithium-ion battery, such as the formation of the solid electrolyte interphase (“SEI”) material or layer during initial charge cycling and the continued growth of the SEI layer during aging, storage, and/or cycling. Due to the fixed lithium budget of a cell, lithium lost due to any side reaction in the cell causes non-stoichiometry of the cathode active material. Conventional approaches to the recycling of battery electrodes typically involve high-temperature chemical (e.g., acid) treatments of an electrode material to separate and/or isolate its main components such as electrode active material(s), conductive additive(s), and/or electrolyte salt(s). These aggressive chemical recovery processes are necessitated by the difficulty in mechanically separating other components of traditional electrode coatings such as binders and/or adhesives. Many such processes are time and labor intensive, costly to implement, and low yielding in terms of useful feedstock materials. Nevertheless, recycling is an ongoing goal of most battery producers, given the variety of valuable components in most battery compositions, and the economic and environmental costs associated with the wholesale disposal of electrochemical cells. Due to the aforementioned challenges, improved methods for the recycling of electrodes are needed.

Embodiments described herein relate generally to methods and/or processes for the remediation (also referred to as “recycling.” “reconstituting.” “reclamation,” “refurbishment,” “repurposing” or “remanufacturing”) of electrodes obtained from electrochemical cells. More specifically, the processes described herein relate to the replenishment, and/or regeneration of lithium lost due to unwanted side reactions in an electrochemical cell resulting in non-stoichiometry of the cathode active materials. These processes, which are also referred to herein as relithiation processes, can be implemented for the replenishment of lithium in electrode active materials included in semisolid electrodes. The relithiation processes described herein can also be implemented for the replenishment of lithium in electrode active materials from conventional battery solid electrodes.

In some embodiments, electrodes described herein can include conventional solid electrodes, for example, electrodes that are sintered or polymerized to have a solid form factor. In some embodiments, the solid electrodes can include binders. In some embodiments, electrodes described herein can include semi-solid electrodes. Semi-solid electrodes described herein can be made: (i) thicker (e.g., greater than 100 μm-up to 2.000 μm or even greater) due to the reduced tortuosity and higher electronic conductivity of the semi-solid electrode. (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless or binder free, and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate. 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary. Fluid Redox Electrode.” and International Patent Publication No. WO 2012/088442, entitled “Semi-Solid Filled Battery and Method of Manufacture.” the entire disclosures of which are hereby incorporated by reference.

In some embodiments, the relithiation processes described herein can include obtaining an electrode active material from a depleted (i.e., used, sub-stoichiometric, non-stoichiometric, or “spent”) electrode material, rinsing and/or washing the obtained electrode active material to remove one or more residues such as electrolyte salt(s), mixing an additive to the electrode active material to replenish lithium lost and produce and/or generate a replenished electrode active material, homogenizing the replenished electrode active material using a mechanical grinding process, and subjecting the replenished electrode active material to a heat treatment process to reestablish its electrochemical activity. The “depleted” electrode material as described herein can include an electrode material that has been formed into an electrode, an electrode material that has been formed into an electrochemical cell, an electrode material that has been used in an electrochemical cell, and/or an electrode a material that has functioned in an electrochemical reaction. In other words, the electrode material that has come into existence as an electrode can be considered a “depleted” electrode material as it is no longer a pristine electrode material. In some embodiments, the electrode material can include substantially depleted, semi-depleted, partially depleted, and almost depleted electrode material.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the value stated. e.g., about 250 μm would include 225 μm to 275 μm, and about 1.000 μm would include 900 μm to 1.100 μm.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “room temperature” and/or “ambient temperature” can refer to a temperature of about 15° C. about 16° C. about 17° C. about 18° C. about 19° C. about 20° C. about 21° C. about 22° C. about 23° C. about 24° C. or about 25° C. In some embodiments, the room temperature is about 20° C. to about 40° C. inclusive (e.g., about 20, 25, 30, 35, or 40° C. inclusive).

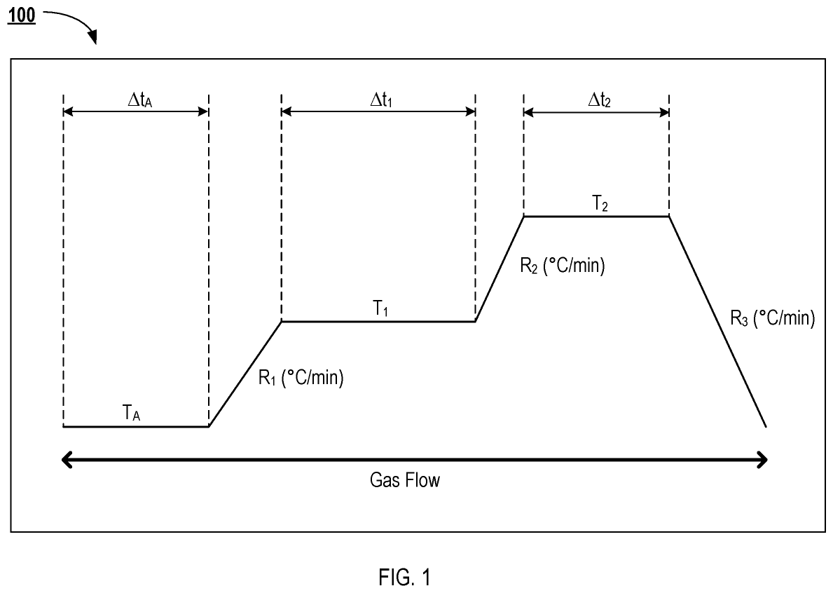

FIG. 1, shows a schematic illustration of a heat treatment process 100 for the relithiation of an electrode active material (e.g., a cathode electrode active material and/or an anode active material), according to an embodiment. The heat treatment process 100 can be used to relithiate an electrode active material obtained from a depleted electrode material from an electrochemical cell that has reached its “end of service.” or that exhibits capacity fade. The depleted or used electrode active material can be obtained from a semisolid electrode (e.g., a semisolid cathode or semisolid anode) or a conventional solid electrode (e.g., a conventional solid cathode or a conventional solid anode). The “depleted” nature of the electrode material refers to an at least partial degradation or loss or gain of material such that the electrode active material is compositionally different from its state at the original assembly of the electrochemical device. For example, due to the loss of cyclable lithium in a lithium-ion battery, the stoichiometry of the cathode electrode active material may be measurably different from that of the a “fresh” cathode electrode active material (i.e., there has been a shift in the relative quantities of its constituents). The heat treatment process 100 can be applied to a cathode electrode active material after the cathode electrode active material has been at least: (1) mixed with an additive to correct its composition, and (2) homogenized using any suitable grinding process, as further described herein. The heat treatment process 100 can be applied to any suitable cathode active material, including, but not limited to, metal-oxide cathodes such as LiCoO₂ (lithium cobalt oxide, “LCO”), Li(Ni, Mn, Co)O₂ (lithium nickel manganese cobalt oxide. “NMC.” which is also referred to as “NCM”). LiNi_{0.8}Co_{0.15}Al_{0.05}O₂ (lithium nickel cobalt aluminum oxide. “NCA”). LiMn₂O₄ (lithium manganese oxide. “LMO”). LiCoPO₄ (lithium cobalt phosphate. “LCP”). LiNiPO₄ (lithium nickel phosphate. “LNP”). LiFePO₄ (lithium iron phosphate. “LFP”). LiMnPO₄ (lithium manganese phosphate. “LMP”). LiMn_{0.85}Fe_{0.15}PO₄ (lithium manganese iron phosphate. “LMFP”), and/or Li₄Ti₅O₁₂ (lithium titanate. “LTO”).

FIG. 1 shows the heat treatment process 100 includes exposing the electrode active material to an initial temperature for a period of time, and then heating the electrode active material according to a multi-step temperature program while flowing a gas stream. The electrode active material may be mixed with an additive before performing the heat treatment process, for example, to facilitate relithiation. In some embodiments the additive may include a lithium-containing additive, including, but not limited to, a lithium carbonate, a lithium hydroxide, a lithium nitrate, or lithium sulfate, or any suitable combination thereof. In some embodiments, the additive can include an iron containing additive, including, but not limited to Fe₃(PO₄)₂·8H₂O, Fe(CH₃CO₂)₂. FeC₂O₄.2H₂O. Fe₃(NO₃)₃, FeCl₃, Fe₂O₃, or any suitable combination thereof. In some embodiments, the additive can include a nickel containing additive, including, but not limited to NiO, NiSO₄.6H₂O, NiCl₂.6H₂O, Ni(NO₃)₂·6H₂O. Ni(CH₃CO₂)₂.4H₂O, Ni(OH)₂, or any suitable combination thereof. In some embodiments, the additive include a manganese containing additive, including, but not limited to MnO₂. MnSO₄.H₂O. MnCl₂.4H₂O. Mn(NO₂)₂.4H₂O. Mn(CH₃CO₂)₂. Mn(OH)₂, or any suitable combination thereof. In some embodiments, the additive can include a cobalt containing additive, including, but not limited to CoO. Co₂O₃, Co₃O₄, CoSO₄.7H₂O, CoCl₂.6H₂O, Co(NO₃)₂·6H₂O, Co(CH₃CO₂)₂·4H₂O, Co(OH)₂, or any suitable combination thereof.

In use, the electrode active material can be disposed in an oven, a furnace, and/or any suitable device capable of heating the electrode active material according to the multi-step temperature program. In some embodiments, a gas stream may be flowed over the electrode active material during heating to provide a controlled atmosphere. In some embodiments the gas stream can be and/or include air. In some embodiments, the gas stream can be and/or include an inert and/or a non-reactive gas such as Helium (He), Argon (Ar), and/or Nitrogen (N₂). In such embodiments, the inert and/or non-reactive gas can be a high purity gas. For example, in some embodiments the gas stream can be and/or include nitrogen gas having a concentration of nitrogen and/or nitrogen purity of about 99.0%(e.g., Nitrogen gas classification N2.0), about 99.90%(e.g., Nitrogen gas classification N3.0), about 99.990%(e.g., Nitrogen gas classification N4.0), or about 99.999%(e.g., Nitrogen gas classification N5.0, also referred to as ultrahigh purity UHP). In some embodiments, the gas stream can be and/or include oxygen (e.g., at least 99% pure oxygen). In some embodiments the gas stream can be a gas mixture comprising an inert and/or non-reactive gas and an oxygen containing gas such as air (e.g., dry or anhydrous air), and/or pure oxygen. In such embodiments, the gas mixture can include the oxygen containing gas at a predetermined concentration. For example, the gas mixture can include the oxygen containing gas at a concentration of at least about 0.5%, of about 1.0%, about 1.5%, about 2.0%, about 3.0%, about 4.0%, about 5.0%, about 10%, about 15%, about 20.0%, about 30%, about 40%, about 50%, about 60%, about 70%, about 80%, about 90%, or about 95%, inclusive of all ranges therebetween. In some embodiments the gas stream can be a gas mixture comprising an inert and/or non-reactive gas and a reducing has such as hydrogen (H₂). In such embodiments, the gas mixture can include hydrogen gas at a predetermined concentration. For example, the gas mixture can include hydrogen gas at a concentration of at least about 0.5%, of about 1.0%, about 1.5%, about 2.0%, about 3.0%, about 4.0%, about 5.0%, about 10%, about 15%, about 20.0%, about 30%, about 40%, about 50%, about 60%, about 70%, about 80%, about 90%, about 95%, or about 99%, inclusive of all ranges therebetween.

In some embodiments, the gas stream can be flowed at a flow rate of about 0 mL/min. at least about 10 mL/min. at least about 20 mL/min. at least about 50 mL/min. at least about 100 mL/min. at least about 150 mL/min. at least about 200 mL/min. at least about 250 mL/min. or at least about 300 mL/min. inclusive of all ranges therebetween. In some embodiments, the gas stream can be flowed at a flow rate of no more than about 300 ml/min, no more than about 270) ml/min. no more than about 240) ml/min. no more than about 210 ml/min. no more than about 180) ml/min. no more than about 150 ml/min. no more than about 120 ml/min. no more than about 90) ml/min, no more than about 60 ml/min. no more than about 30 ml/min. or no more than about 10 ml/min. inclusive of all ranges therebetween.

FIG. 1 shows the heat treatment process 100 includes exposing the electrode active material to room temperature and/or ambient temperature (T_{A}) for a period of time Δt_{A} while providing a gas flow (e.g., flowing a gas stream). In some embodiments, the period of time Δt_{A} can be at least about 0.1 h, at least about 0.2 h, at least about 0.3 h, at least about 0.5 h, at least about 1 h, at least about 1.5 h, at least about 2 h, at least about 2.5 h, at least about 3 h, at least about 3.5 h, at least about 4 h, at least about 4.5 h, at least about 5 h, at least about 6 h, at least about 7 h, at least about 8 h, at least about 9 h, at least about 10 h, at least about 15 h, at least about 20 h. or at least about 24 h. inclusive of all ranges therebetween. In some embodiments, the period of time Δt_{A} can be no more than about 24 h, no more than about 20 h, no more than about 16 h. no more than about 12 h, no more than about 8 h no more than about 4 h no more than about 2 h. no more than about 1 h no more than about 0.5 h, no more than about 0.1 h, inclusive of all ranges therebetween. In some embodiments, the electrode active material includes LFP and the gas flow includes nitrogen (e.g., 99.999% nitrogen). In some embodiments, the electrode active material includes NMC and the gas flow includes oxygen and/or dry air.

Following the exposure to ambient temperature T_{A} for the period of time Δt_{A}, the electrode active material can be heated at a first heating rate R₁ from ambient temperature T_{A} to a first temperature (T₁) (e.g., an intermediate temperature) flowing a gas stream, for example, the same gas flow or gas stream used during the period of time Δt_{A}. In some embodiments, he electrode active material can then be held at the first temperature T₁ for a first period of time Δt₁. In some embodiments, the first temperature T₁ can be at least about 150° C., at least about 175° C., at least about 200° C., at least about 225° C., at least about 250° C.), at least about 275° C., at least about 300° C., at least about 325° C., at least about 350° C., at least about 400° C., at least about 450° C.), at least about 500° C., or at least about 550° C., inclusive of all ranges therebetween. In some embodiments, the first temperature T₁ can be no more than about 550° C.), no more than about 500° C.), no more than about 450° C., no more than about 400° C., no more than about 350° C., no more than about 330° C., no more than about 310° C., no more than about 300° C., no more than about 280° C., no more than about 260° C., no more than about 240° C., no more than about 220° C., no more than about 200° C., no more than about 180° C., no more than about 160° C., or no more than about 140° C., inclusive of all ranges therebetween. Combinations of the above-referenced ranges for the first temperature T₁ are also possible (e.g., at least about 150° C., and less than about 5500° C.), at least about 200° C., and less than about 500° C., or in a range between about 150° C. and about 550° C. inclusive). In some embodiments, the temperature is one of about 250° C., or about 450) 0

In some embodiments, the first period of time Δt₁ can be at least about 0 hours (“h”), at least about 0.5 h, at least about 1 h, at least about 1.5 h, at least about 2 h, at least about 2.5 h, at least about 3 h, at least about 3.5 h, at least about 4 h, at least about 4.5 h, at least about 5 h, at least about 6 h, at least about 7 h, or at least about 8 h, inclusive of all ranges therebetween. In some embodiments, the first period of time Δt₁ can be no more than about 8 h, no more than about 7 h no more than about 6 h, no more than about 5 h, no more than about 4 h, no more than about 3 h, no more than about 2 h, no more than about 1 h, or no more than about 0.5 h, inclusive of all ranges therebetween. In some embodiments, the first period of time Δt₁ can be one of about 0 h, about 3 h, or about 5 h. In some embodiments, the first period of time Δt₁ is (h. In such embodiments, instead of holding the electrode active material at the first temperature T₁, the electrode active material can continue to be heated to a second temperature T₂ higher than the first temperature (described in further detail herein), without holding the electrode active material at the first temperature T₁. In other words, in such embodiments, the operation of holding the electrode active material at the first temperature T₁ can be skipped.

In some embodiments the gas stream flowed during heating of the electrode active material from ambient temperature T_{A} to the first temperature T₁ and/or while maintaining the electrode active material at the first temperature T₁ can be substantially the same as the gas stream flowed when the electrode active material is kept at ambient temperature T_{A}. In other embodiments the gas stream flowed during heating of the electrode active material from ambient temperature T_{A} to the first temperature T₁ and/or while maintaining the electrode active material at the first temperature T₁ can be different from the gas stream flowed when the electrode active material is kept at ambient temperature T_{A}.

Following the exposure to the first temperature T₁ for the first period of time Δt₁, the electrode active material can be heated at a second heating rate R₂ from the first temperature T₁ to a second temperature T₂ while flowing a gas stream. The cathode active material can then be held at the second temperature T₂ for a second period of time Δt₂. In some embodiments, the second temperature T₂ can be at least about 500° C., at least about 550° C., at least about 600° C., at least about 650° C., at least about 700° C., at least about 750° C., at least about 800° C., at least about 850° C.) at least about 900° C., at least about 950° C., or at least about 1.000° C. inclusive of all ranges therebetween. In some embodiments, the second temperature T₂ can be no more than about 1.000° C. no more than about 950° C. no more than about 900° C. 850° C. no more than about 840° C. no more than about 800° C. no more than about 760° C. no more than about 720° C. no more than about 680° C. no more than about 640° C.) no more than about 600° C. no more than about 560° C. no more than about 520° C. or no more than about 500° C. inclusive of all ranges therebetween. Combinations of the above-referenced ranges for the second temperature T₂ are also possible (e.g., at least about 650° C. and less than about 750° C.) at least about 680° C. and less than about 720° C.) or in a range between about 600° C. and about 1.000° C.).

In some embodiments, the second period of time Δt₂ can be at least about 0.1 h, at least about 0.2 h, at least about 0.5 h, at least about 0.7 h, at least about 1.0 h, at least about 1.5 h, at least about 2.0 h, at least about 2.5 h, at least about 3.0 h, at least about 4.0 h, at least about 5.0 h, at least about 6.0 h, at least about 7.0 h, at least about 8.0 h, at least about 9.0 h, at least about 10.0 h, at least about 11.0 h, at least about 12.0 h, at least about 13.0 h, at least about 14.0 h, at least about 15.0 h, or at least about 20.0 h, inclusive of all ranges therebetween. In some embodiments, the second period of time Δt₂ can be no more than about 20 h, no more than about 15 h, no more than about 14 h, no more than about 13 h, no more than about 12 h, no more than about 11 h, no more than about 10 h, no more than about 9 h, no more than about 8 h, no more than about 7 h, no more than about 6 h, no more than about 5 h, no more than about 4 h, no more than about 3.0 h no more than about 2.8 h, no more than about 2.6 h, no more than about 2.4 h, no more than about 2.2 h, no more than about 2.0 h, no more than about 1.8 h, no more than about 1.6 h, no more than about 1.4 h, no more than about 1.2 h, no more than about 1.0 h, no more than about 0.8 h, no more than about 0.6 h, no more than about 0.4 h, or no more than about 0.2 h, inclusive of all ranges therebetween. Combinations of the above-referenced ranges for the second period of time Δt₂ are also possible (e.g., at least about 0.5 h, and less than about 20 h at least about 1 h, and less than about 18 h, or in a range between about 0.5 h and about 20 h).

In some embodiments the gas stream flowed during heating of the electrode active material from the first temperature T₁ to the second temperature T₂ and/or while maintaining the electrode active material at the second temperature T₂ can be substantially the same as the gas stream flowed when the electrode active material is kept at ambient temperature T_{A}, and/or when the electrode active material is kept at the first temperature T₁. In other embodiments, the gas stream flowed during heating of the electrode active material from the first temperature T₁ to the second temperature T₂ and/or while maintaining the electrode active material at the second temperature T₂ can be different from the gas stream flowed when: (1) the electrode active material is kept at ambient temperature T_{A}; and/or (2) when the electrode active material is kept at the first temperature T₁.

Following the exposure to the second temperature T₂ for the second period of time Δt₂, the electrode active material can be cooled at a cooling rate Ra from the second temperature T₂ to ambient temperature T_{A} flowing a gas stream. In some embodiments the first heating rate R₁, the second heating rate R₂, and the cooling rate R₃ can be at least about 0.5° C./min, at least about 1.0° C./min, at least about 1.5° C./min, at least about 2.0° C./min, at least about 2.5° C./min, at least about 3.0° C./min, at least about 3.5° C./min, at least about 4.0° C./min, at least about 4.5° C./min, at least about 5.0° C./min, at least about 5.5° C./min, at least about 6.0° C./min, at least about 6.5° C./min, at least about 7.0° C./min, at least about 7.5° C./min, at least about 8.0° C./min, at least about 8.5° C./min, at least about 9.0° C./min, at least about 9.5° C./min, or at least about 10° C./min, inclusive of all ranges therebetween. In some embodiments the first heating rate R₁, the second heating rate R₂, and the cooling rate Ra can be no more than 10° C./min, no more than 9.0° C./min, no more than 8.0° C./min, no more than 7.0° C./min, no more than 6.0° C./min, no more than 5.0° C./min, no more than 4.0° C./min, no more than 3.0° C./min, no more than 2.0° C./min, no more than 1° C./min, or no more than 0.5° C./min, inclusive of all ranges therebetween. Combinations of the above-referenced ranges for the first heating rate R₁, the second heating rate R₂, and the cooling rate R₃ are also possible (e.g., at least about 1° C./min, and less than about 3° C./min. or at least about 4.5° C./min. and less than about 5.5° C./min).

In some embodiments, the first heating rate R₁, the second heating rate R₂, and the cooling rate Ra can be substantially the same. For example, in some embodiments the first heating rate R₁, the second heating rate R₂, and the cooling rate Ra can be about 5° C./min. In other embodiments, the first heating rate R₁, can be different from the second heating rate R₂, and/or the cooling rate R₃. In some embodiments, the first heating rate R₁, the second heating rate R₂, and the cooling rate R₃ can each be different from each other. For example, in some embodiments the first heating rate R₁ can be about 0.5° C./min. the second heating rate R₂ can be about 5° C./min. and the cooling rate Ra can be about 3.5° C./min.

In some embodiments the gas stream flowed during cooling of the cathode active material from the second temperature T₂ to the ambient temperature T_{A} can be substantially the same as the gas stream flowed when the cathode active material is kept at ambient temperature T_{A}, at the first temperature T₁, and/or at the second temperature T₂. In other embodiments, the gas stream flowed during cooling of the cathode active material from the second temperature T₂ to ambient temperature T_{A} can be different from the gas stream flowed when the cathode active material is kept at ambient temperature T_{A}, at the first temperature T₁, and/or at the second temperature T₂.

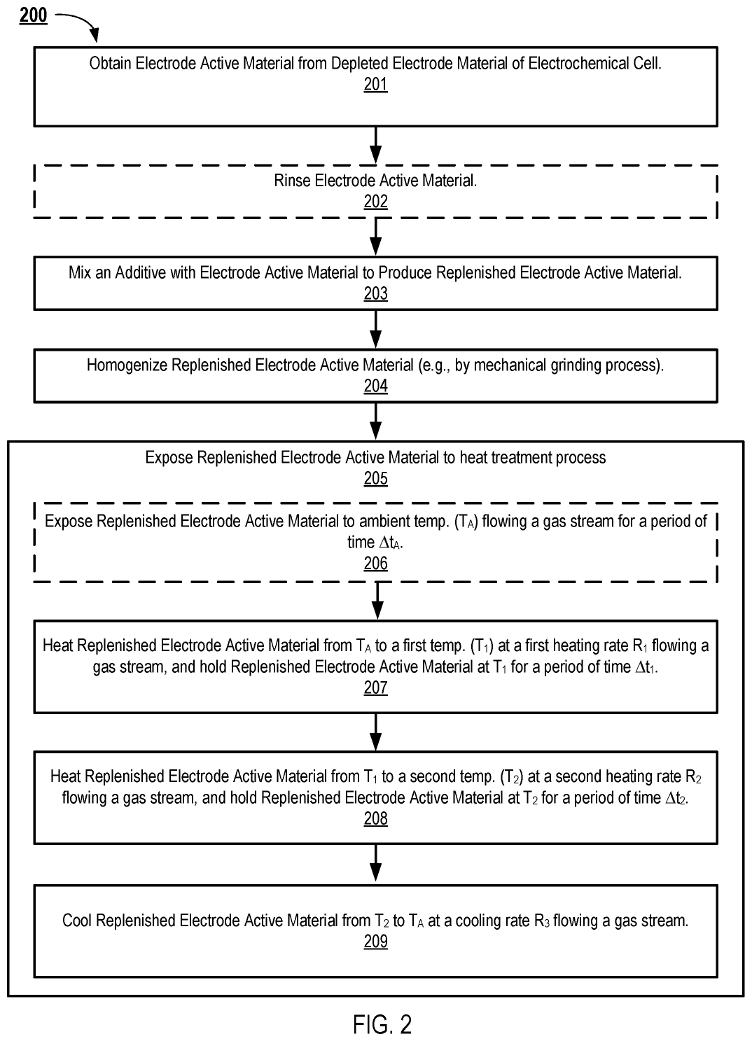

FIG. 2 is a flow diagram showing a process 200 for the relithiation of an electrode active material, according to an embodiment. According to the relithiation process 200, an electrode active material is first obtained at step 201 from a depleted electrode material included in an electrochemical cell that has reached its “end of service.” or that exhibits capacity fade. As described above, the “depleted” nature of the electrode material refers to an at least partial degradation or loss or gain of material such that the electrode active material is compositionally different from its state at the original assembly of the electrochemical device. Step 201 may involve disassembly of an electrochemical cell, and separation of the depleted electrode materials (e.g., cathode and anode) from other components of the electrochemical cell such as a separator and/or current collectors. The separation of the depleted electrode materials from the electrochemical cell can include mechanical removal, for example by scraping, brushing, crumpling of the current collector such that the depleted electrode materials flakes off, etc. In some embodiments, the separation of the depleted electrode materials from the electrochemical cell does not involve the use of chemicals (i.e., is only mechanical). In some embodiments, the separation of the depleted electrode materials from the electrochemical cell includes the “clean” removal of the electrode materials from its respective current collector (i.e., such that little or no damage is done to the current collector, and/or substantially none of the current collector material is present in the separated electrode material). Mechanical separation (i.e., from a current collector) of a depleted semi-solid electrode material, in particular, may require only a low applied force to remove, for example due to its semi-solid physical state and/or the absence of a binder.

In some embodiments, the depleted electrode material can be a semi-solid stationary cathode or a semi-solid flowable cathode, for example of the type used in redox flow cells. The depleted cathode electrode material can include a cathode electrode active material such as a lithium bearing compound. In some embodiments, electrode active materials for the semi-solid cathode can include the general family of ordered rocksalt compounds LiMO₂ including those having the α-NaFeO₂ (so-called “layered compounds”) or orthorhombic-LiMnO₂ structure type or their derivatives of different crystal symmetry, atomic ordering, or partial substitution for the metals or oxygen. M includes at least one first-row transition metal but may include non-transition metals including but not limited to Al, Ca, Mg, or Zr. Examples of such compounds include LiCoO₂. LiCoO₂ doped with Mg, LiNiO₂, Li(Ni, Co, Al)O₂ (known as “NCA”) and Li(Ni, Mn, Co)O₂ (known as “NMC” or “NCM”). Other families of exemplary cathode electrode active materials includes those of spinel structure, such as LiMn₂O₄ and its derivatives, so-called “layered-spinel nanocomposites” in which the structure includes nanoscopic regions having ordered rocksalt and spinel ordering, olivines LiMPO₄ and their derivatives, in which M comprises one or more of Mn. Fe. Co. or Ni, partially fluorinated compounds, such as LiVPO₄F, other “polyanion” compounds as described below, and vanadium oxides VₓO_{y} including V₂O₅ and V₆O₁₁.

In some embodiments, the semi-solid cathode electrode active material includes a transition metal polyanion compound, for example as described in U.S. Pat. No. 7,338,734, the entire disclosure of which is incorporated herein by reference. In some embodiments the electrode active material includes an alkali metal transition metal oxide or phosphate, and for example, the compound has a composition Aₓ(M′₁₋ₐM″ₐ)_{y}(XD₄)_{z}. Aₓ(M′₁₋ₐM″ₐ)_{y}(DXD₄)_{z}, or Aₓ(M′₁₋ₐM″ₐ)_{y}(X₂D₇)_{z}, and have values such that x, plus y(1-a) times a formal valence or valences of M′, plus ya times a formal valence or valence of M″, is equal to z times a formal valence of the XD₄. X₂D₇, or DXD₄ group: or a compound comprising a composition (A₁₋ₐM″ₐ)ₓM′_{y}(XD₄)_{z}. (A₁₋ₐM″ₐ)ₓM′_{y}(DXD₄)/(A₁₋ₐM″ₐ)ₓM′_{y}(X₂D₇), and have values such that (1-a)x plus the quantity ax times the formal valence or valences of M″ plus y times the formal valence or valences of M′ is equal to z times the formal valence of the XD₄. X₂D₇ or DXD₄ group. In the compound, A is at least one of an alkali metal and hydrogen. M′ is a first-row transition metal, X is at least one of phosphorus, sulfur, arsenic, molybdenum, and tungsten. M″ any of a Group IIA, IIIA, IVA, VA, VIA, VIIA, VIIIA, IB, IIB, IIIB, IVB, VB, and VIB metal. D is at least one of oxygen, nitrogen, carbon, or a halogen. The cathode electrode active material can be an olivine structure compound LIMPO₄, where M is one or more of V, Cr, Mn, Fe, Co, and Ni, in which the compound is optionally doped at the Li. M or O-sites. Deficiencies at the Li-site are compensated by the addition of a metal or metalloid, and deficiencies at the O-site are compensated by the addition of a halogen. In some embodiments, the cathode electrode active material includes a thermally stable, transition-metal-doped lithium transition metal phosphate having the olivine structure and having the formula (Li₁₋ₓZₓ)MPO₄, where M is one or more of V, Cr, Mn, Fe, Co, and Ni, and Z is a non-alkali metal dopant, such as one or more of Ti, Zr, Nb, Al, or Mg, and x ranges from 0.005 to 0.05, inclusive.

In other embodiments, the lithium transition metal phosphate material has an overall composition of Li_{1-x-z}M_{1+z}PO₄, where M includes at least one first row transition metal selected from the group consisting of Ti, V, Cr, Mn, Fe, Co and Ni, where x is from 0 to 1 and z can be positive or negative. M includes Fe, z is between about 0.05-0.15, inclusive. The material can exhibit a solid solution over a composition range of (<<<0.15, or the material can exhibit a stable solid solution over a composition range of x between 0) and at least about 0.05, or the material can exhibit a stable solid solution over a composition range of x between 0) and at least about 0.07 at room temperature (22-25° C.). The material may also exhibit a solid solution in the lithium-poor regime, e.g., where x≥0.8, or x≥0.9, or x≥0.95.

The depleted electrode material can also include a conductive additive such as, for example, graphite, carbon powder, pyrolytic carbon, carbon black, carbon fibers, carbon microfibers, carbon nanotubes (CNTs), single walled CNTs, multi walled CNTs, fullerene carbons including “bucky balls,” graphene sheets and/or aggregate of graphene sheets, any other conductive material, alloys or combination thereof. The depleted cathode electrode material can also include a non-aqueous liquid electrolyte as described in further detail below. In some embodiments, the depleted cathode electrode material can include cathode electrode active materials and optionally conductive additives in particulate form suspended in a non-aqueous liquid electrolyte. In some embodiments, the conductive additives have shapes, which may include spheres, platelets, or rods to optimize solids packing fraction, increase the semi-solid's net electronic conductivity, and improve rheological behavior of semi-solids. In some embodiments, low aspect or substantially equiaxed or spherical particles are used to improve the ability of a semi-solid electrode material to flow under stress.

In some embodiments, the particles have a plurality of sizes so as to increase packing fraction. In particular, the particle size distribution can be bi-modal, in which the average particle size of the larger particle mode is at least 5 times larger than average particle size of the smaller particle mode. In some embodiments, the mixture of large and small particles improves flow of the material during cell loading and increases solid volume fraction and packing density in the loaded cell.

In some embodiments, the depleted electrode material (e.g., cathode and/or anode) can include about 35% to about 75% by volume of an active material. In some embodiments, the depleted electrode material can include about 40% to about 75% by volume. 45% to about 75% by volume, about 50% to about 75% by volume, about 55% to about 75% by volume, about 60% to about 75% by volume, or about 65% to about 75% by volume of a cathode active material, inclusive of all ranges therebetween. In some embodiments, the depleted cathode electrode material can include about 0.5% to about 8% by volume of a conductive additive. In some embodiments, the depleted electrode material can include about 0.6% to about 7.5% by volume, about 0.7% to about 7.0% by volume, about 0.8% to about 6.5% by volume, about 0.9% to about 6% by volume, about 1.0% to about 6%, about 1.5% to about 5.0% by volume, or about 2% to about 4% by volume of a conductive additive, inclusive of all ranges therebetween. In some embodiments, the depleted electrode material can include about 25% to about 70% by volume of an electrolyte. In some embodiments, the electrode can include about 30% to about 50%, or about 20% to about 40% by volume of an electrolyte, inclusive of all ranges therebetween.

In some embodiments, the depleted cathode (and/or the anode) electrode can have a thickness of less than 100 μm (final single sided coated thickness). In some embodiments, the cathode (e.g., a semi-solid cathode) and/or the anode (e.g., a semi-solid anode) can have a thickness in the range of about 250 μm to about 2.000 μm. In some embodiments, the cathode and/or the anode can have a thickness in the range of about 250 μm to about 600 μm, about 300 μm to about 600 μm, about 350 μm to about 600 μm, about 400 μm to about 600 μm, about 450 μm to about 600 μm, or about 500 μm to about 600 μm, inclusive of all ranges therebetween.

Optionally, at step 202, the relithiation process 200 includes rinsing the electrode active material to remove one or more residues, such as electrolyte salt(s), electrolyte solvent, or a reaction product including but not limited to a solid-electrolyte-interphase (SEI) formed during the operation of the battery. The rinse medium can be any polar organic solvent, such as dimethyl carbonate (“DMC”) or any solvent that is miscible with the electrolyte and in which the electrolyte salt(s) is soluble. For example, solvents may include but are not limited to ethylene carbonate, propylene carbonate, butylene carbonate, and their chlorinated or fluorinated derivatives, and a family of acyclic dialkyl carbonate esters, such as dimethyl carbonate, diethyl carbonate, ethylmethyl carbonate, dipropyl carbonate, methyl propyl carbonate, ethyl propyl carbonate, dibutyl carbonate, butylmethyl carbonate, butylethyl carbonate and butylpropyl carbonate, y-butyrolactone, dimethoxyethane, tetrahydrofuran. 2-methyl tetrahydrofuran. 1.3-dioxolane. 4-methyl-1.3-dioxolane, diethyl ether, sulfolane, methylsulfolane, acetonitrile, propiononitrile, ethyl acetate, methyl propionate, ethyl propionate, dimethyl carbonate, tetraglyme, and the like. The rinse can be performed, for example, by immersion of the depleted electrode material in the rinse medium/solvent with or without agitation. Further details and/or examples of the rinsing step 202 are described in U.S. Pat. No. 10,411,310, titled “Methods for Electrochemical Cell Remediation.” and issued Sep. 10, 2019, the entire disclosure of which is hereby incorporated by reference.

At step 203, the relithiation process 200 includes mixing and/or adding an additive to the electrode active material to produce a replenished electrode active material. The addition of an additive to the electrode active material can compensate for “missing” lithium lost during cycling of the electrochemical cell. In some embodiments, the additive(s) comprise a lithium source, such as lithium carbonate, lithium hydroxide, lithium nitrate, lithium sulfate, or any lithium salt. In such embodiments, the lithium source can be mixed and/or added to replenish an amount of lithium loss on the electrode active material due to cycling of the electrochemical cell. In some embodiments, the additive can include an iron containing additive, including, but not limited to Fe₃(PO₄)₂·8H₂O, Fe(CH₃CO₂)₂, FeC₂O₄·2H₂O. Fe₃(NO₃)₃, FeCl₃, Fe₂O₃, or any suitable combination thereof. In some embodiments, the additive can include a nickel containing additive, including, but not limited to NIO, NiSO₄·6H₂O. NiCl₂·6H₂O. Ni(NO₃)₂·6H₂O. Ni(CH₃CO₂)₂·4H₂O. Ni(OH)₂, or any suitable combination thereof. In some embodiments, the additive can include a manganese containing additive, including, but not limited to MnO₂, MnSO₄·H₂O, MnCl₂·4H₂O, Mn(NO₂)₂·4H₂O, Mn(CH₃CO₂)₂, Mn(OH)₂, or any suitable combination thereof. In some embodiments, the additive can include a cobalt containing additive, including, but not limited to CoO. Co₂O₃, Co₃O₄, CoSO₄·7H₂O, CoCl₂·6H₂O, Co(NO₃)₂·6H₂O. Co(CH₃CO₂)₂·4H₂O. Co(OH)₂, or any suitable combination thereof.

The amount of lithium-containing additive(s), or any other additive desired to be mixed and/or added to the electrode active material in step 203 can be determined from analysis of the chemical composition of the electrode active material. For example, in some embodiments the electrode active material can be characterized by inductively Coupled Plasma Mass Spectrometry (ICP-MS) to determine its elemental chemical composition. More specifically, the electrode active material can be analyzed via ICP-MS to determine an amount and/or degree of lithium present on the electrode active material. This amount and/or degree of lithium present on the electrode active material can be compared with the amount of lithium present in a pristine electrode active material (e.g., a “fresh” electrode active material which has not been subjected to cycling on an electrochemical cell). For example, in some instances a “fresh” NCM 111 electrode active material can have a composition Li_{1.17}Ni_{0.37}Co_{0.38}Mn_{0.38}O₂ and a lithium-to-transition-metal ratio of about 1.04 determined from ICP-MS analysis. An NCM electrode active material included in a depleted electrode material (originally NCM 111) can have a composition of Li_{0.84}Ni_{0.63}Co_{0.25}Mn_{0.38}O₂ and a lithium-to-transition-metal ratio of about 0.66 (i.e., a loss of lithium of about 36.5% as compared with fresh NCM 111) as determined from ICP-MS analysis. Accordingly, the amount of lithium-containing additive required to be mixed and/or added to the electrode active material in step 204 can be determined as a mass or weight of the lithium-containing additive which includes sufficient lithium to replenish the 36.5% lithium lost.

In some embodiments, the amount of additive to be mixed and/or added to an electrode active material can be a mass or weight of additive which includes sufficient lithium to replenish about a 1% lost lithium, about a 2% lost lithium, about a 3% lost lithium, about a 5% lost lithium, about a 8% lost lithium, about a 10% lost lithium, about a 12% lost lithium, about a 15% lost lithium, about a 20% lost lithium, about a 25% lost lithium, about a 30% lost lithium, about a 35% lost lithium, about a 40% lost lithium, about a 45% lost lithium, about a 50% lost lithium, about a 55% lost lithium, about a 60% lost lithium, about a 65% loss lithium, or about a 70% loss lithium, inclusive of all ranges therebetween. In some embodiments, the amount of additive mixed or added to the electrode active material can be mixed in an amount sufficient to replenish at least about 1%, at least about 2%, at least about 3%, at least about 4%, or at least about 5% active material (e.g., lithium, Mn, P, Fe, Co, Ni, etc.) lost from the electrode active material.

At step 204, the relithiation process 200 includes homogenizing the replenished electrode active material. In some embodiments, the homogenizing of the replenished electrode active material involves pulverization or grinding the replenished electrode active material using a suitable mechanical griding process. In some embodiments, the homogenizing step 205 includes loading the replenished electrode material in a container with ceramic griding media, and mixing the replenished electrode material for a period of time in a batch process. In some embodiments, the homogenizing of the replenished electrode active material can be performed with, for example, any one of a high shear mixer, a planetary mixer, a centrifugal planetary mixture, a sigma mixture, a CAM mixture, and/or a roller mixture. In some embodiments, the mixing of the electrode material can supply a specific mixing energy of at least about 90 J/g, at least about 100 J/g, about 90 J/g to about 150 J/g, or about 100 J/g to about 120 J/g, inclusive of all ranges therebetween. In some embodiments, process conditions (temperature: shear rate or rate schedule: component addition sequencing, location, and rate: mixing or residence time) can be selected and/or modified to control the electrical, rheological, and/or compositional (e.g., uniformity) properties of the homogenized replenished electrode active material. In some embodiments, the mixing element (e.g., roller blade edge) velocity can be between about 0.5 cm/s and about 50 cm/s, inclusive. In some embodiments, the minimum gap between which fluid is being flowed in the mixing event (e.g. distance from roller blade edge to mixer containment wall) can be between about 0.05 mm and about 5 mm, inclusive. Therefore, the shear rate (velocity scale divided by length scale) is accordingly between about 1 and about 10.000 inverse seconds, inclusive. In some embodiments the shear rate can be less than 1 inverse second, and in others it is greater than 10.000 inverse seconds.

At step 205, the relithiation process 200 includes exposing and/or subjecting the replenished electrode active material to heat process treatment. In some embodiments, the heat process treatment can be similar to and/or substantially the same as the heat treatment process 100 described above with reference to FIG. 1. For example, at step 206 the relithiation process 200 optionally include exposing the replenished electrode active material to ambient temperature T_{A} for a period of time Δt_{A} while providing a glass flow (e.g., flowing a gas stream). The period of time Δt_{A} can be at least about 0.1 h, at least about 0.2 h, at least about 0.3 h, at least about 0.5 h. at least about 1 h, at least about 1.5 h, at least about 2 h, at least about 2.5 h, at least about 3 h. at least about 3.5 h, at least about 4 h, at least about 4.5 h, at least about 5 h, at least about 6 h. at least about 7 h, at least about 8 h, at least about 9 h, at least about 10 h, at least about 15 h, at least about 20 h. or at least about 24 h. inclusive of all ranges therebetween. In some embodiments. the period of time Δt_{A} can be no more than about 24 h, no more than about 20 h, no more than about 16 h, no more than about 12 h, no more than about 8 h, no more than about 4 h, no more than about 2 h, no more than about 1 h, no more than about 0.5 h, or no more than about 0.1 h. inclusive of all ranges therebetween.

In some embodiments, exposure of the replenished electrode active material to ambient temperature T_{A} at step 206 can facilitate removing oxygen and moisture present in the replenished electrode active material. In some embodiments, the gas stream flowed during exposure to ambient temperature T_{A} in step 206 can be an inert be and/or include an inert and/or a non-reactive gas such as Helium (He). Argon (Ar), and/or Nitrogen (N₂). In such embodiments, the inert and/or non-reactive gas can be a high purity gas. For example, in some embodiments the gas stream can be and/or include nitrogen gas having a concentration of nitrogen and/or nitrogen purity of about 99.999%(e.g., Nitrogen gas classification N5.0, also referred to as ultrahigh purity UHP). In some embodiments, the gas can include a reactive gas, for example, oxygen (e.g., 99.99% oxygen). and/or air (e.g., dry or anhydrous air). In other embodiments, the gas stream can be a gas mixture including a first component and/or a second component. The first component can be an inert and/or non-reactive gas. The second component can be an oxygen-containing has such as air or pure oxygen, or a reducing gas such as Hydrogen. In such embodiments, the gas mixture can include the second component at a predetermined concentration. For example, the gas mixture can include the second component at a concentration of at least about 0.5%, of about 1.0%, about 1.5%, about 2.0%, about 3.0%, about 4.0%, about 5.0%, about 10%, about 15%, about 20.0%, about 30%, about 40%, about 50%, about 60%, about 70%, about 80%, about 90%, or about 95%, inclusive of all ranges therebetween.

In some embodiments, the gas stream can be flowed during step 206 at a flow rate of 0 mL/min. at least about 10 mL/min, at least about 20 mL/min, at least about 50 mL/min. at least about 100 mL/min. at least about 150 mL/min. at least about 200 mL/min. at least about 250) mL/min. or at least about 300 mL/min, inclusive of all ranges therebetween. In some embodiments, the gas stream can be flowed at a flow rate of no more than about 300 ml/min. no more than about 270) ml/min. no more than about 240) ml/min, no more than about 210 ml/min. no more than about 180 ml/min, no more than about 150 ml/min, no more than about 120 ml/min. no more than about 90 ml/min, no more than about 60 ml/min. no more than about 30 ml/min. or no more than about 10 ml/min, inclusive of all ranges therebetween.

At step 207 the relithiation process 200 includes: (1) heating the replenished electrode active material from ambient temperature (T_{A}) to a first temperature (T₁) at a first heating rate R₁ flowing a gas stream, and (2) holding the replenished electrode active material at the first temperature T₁ for a first period of time Δt₁ in flowing the gas stream. The gas stream flowed at step 207 is selected to generate a control atmosphere similar to the atmosphere used in the original production of the electrode material (i.e., prior to depletion, or in its original manufacture). For example, in some embodiments the replenished electrode active material may include metal-oxide cathodes such as LiCoO₂ (lithium cobalt oxide, “LCO”), Li(Ni, Mn, Co)O₂ (lithium nickel manganese cobalt oxide, “NMC,” which is also referred to as “NCM”), LiNi_{0.8}Co_{0.15}Al_{0.05}O₂ (lithium nickel cobalt aluminum oxide, “NCA”), LiMn₂O₄ (lithium manganese oxide, “LMO”), LiCoPO₄ (lithium cobalt phosphate, “LCP”), and/or LiNiPO₄ (lithium nickel phosphate, “LNP”), In such embodiments, the gas stream flowed at step 207 can be an inert and/or an oxidizing gas (e.g., generating an inert or an oxidizing atmosphere). That is, the gas stream can be a gas mixture comprising an inert gas, and/or an oxygen-containing gas such as air or pure oxygen. Furthermore, the gas mixture can include the oxygen-containing gas at a predetermined concentration. For example, the gas mixture can include the oxygen containing gas at a concentration of at least about 0%, about 0.5%, of about 1.0%, about 1.5%, about 2.0%, about 3.0%, about 4.0%, about 5.0%, about 10%, about 15%, about 20.0%, about 30%, about 40%, about 50%, about 60%, about 70%, about 80%, about 90%, about 95% or about 100%, inclusive of all ranges therebetween.

In some embodiments, the replenished electrode active material may include LiFePO₄ (lithium iron phosphate, “LFP”), LiMnPO₄ (lithium manganese phosphate, “LMP”), LiMn₁₋ₓFeₓPO₄ (lithium manganese iron phosphate, “LMFP”), and Li₄Ti₅O₁₂ (lithium titanate, “LTO”). In such embodiments, the gas stream flowed at step 207 can be an inert or a reducing gas (e.g., generating an inert or a reducing atmosphere). That is, the gas stream can be a gas mixture comprising an inert gas, and/or a reducing gas such as hydrogen. The gas mixture can include the hydrogen-containing gas at a predetermined concentration. For example, the gas mixture can include the hydrogen gas at a concentration of at least about 0%, about 0.5%, of about 1.0%, about 1.5%, about 2.0%, about 3.0%, about 4.0%, about 5.0%, about 10%, about 15%, about 20.0%, about 30%, about 40%, about 50%, about 60%, about 70%, about 80%, about 90%, about 95% or about 100%, inclusive of all ranges therebetween.

In some embodiments, the first period of time Δt₁ can be at least about 0 h, at least about 0.5 h, at least about 1 h, at least about 1.5 h, at least about 2 h, at least about 2.5 h, at least about 3 h, at least about 3.5 h, at least about 4 h, at least about 4.5 h, at least about 5 h, at least about 6 h, at least about 7 h, or at least about 8 h, inclusive of all ranges therebetween. In some embodiments, the first period of time Δt₁ can be no more than about 8 h no more than about 7 h no more than about 6 h, no more than about 5 h no more than about 4 h, no more than about 3 h, no more than about 2 h, no more than about 1 h, or no more than about 0.5 h, inclusive of all ranges therebetween. In some embodiments, the first period of time Δt₁ can be one of about (h, about 3 h, or about 5 h. In some embodiments, the first period of time Δt₁ is (h. In such embodiments, instead of holding the electrode active material at the first temperature T₁, the electrode active material can continue to be heated to a second temperature T₂ higher than the first temperature (described in further detail herein), without holding the electrode active material at the first temperature T₁. In other words, in such embodiments, the operation of holding the electrode active material at the first temperature T₁ can be skipped.

In some embodiments, the gas stream used at step 207 can be flowed at a flow rate similar to the flow rates disclosed above with respect to the step 206 (e.g., a flow rate in the range of 10 to 300 mL/min).

In some embodiments, the first temperature T₁ can be at least about 150° C., at least about 175° C., at least about 200° C., at least about 225° C., at least about 250° C., at least about 275° C., at least about 300° C., at least about 325° C., at least about 350° C., at least about 400° C. at least about 450° C., at least about 500° C. or at least about 550° C. inclusive of all ranges therebetween. In some embodiments, the first temperature T₁ can be no more than about 550° C.) no more than about 500° C. no more than about 450° C. no more than about 400° C. no more than about 350° C. no more than about 330° C. no more than about 310° C. no more than about 300° C. no more than about 280° C. no more than about 260° C. no more than about 240° C. no more than about 220° C. no more than about 200° C. no more than about 180° C. no more than about 160° C. or no more than about 140° C. inclusive of all ranges therebetween. Combinations of the above-referenced ranges for the first temperature T₁ are also possible (e.g., at least about 150° C. and less than about 260° C. or at least about 200° C. and less than about 300° C. or in a range between about 150° C. and about 550° C. inclusive). In some embodiments, the temperature is one of about 250° C.) or about 450° C.)

At step 208, the relithiation process 200 includes: (1) heating the replenished electrode active material from the first temperature T₁ to a second temperature (T₂) at a second heating rate R₂ flowing a gas stream, and (2) holding the replenished electrode active material at the second temperature T₂ for a second period of time Δt₂ in flowing the gas stream. As disclosed abode with reference to step 207, the gas stream flowed at step 208 is selected to generate a control atmosphere similar to the atmosphere used in the original production of the electrode material (i.e., prior to depletion, or in its original manufacture). For example, in embodiments in which the replenished electrode active material includes metal-oxide cathodes such as LiCoO₂ (lithium cobalt oxide, “LCO”), Li(Ni, Mn, Co)O₂ (lithium nickel manganese cobalt oxide, “NMC,” also referred to as “NCM”), LiNi_{0.8}Co_{0.15}Al_{0.05}O₂ (lithium nickel cobalt aluminum oxide, “NCA”), LiMn₂O₄ (lithium manganese oxide, “LMO”), LiCoPO₄ (lithium cobalt phosphate, “LCP”), and/or LiNiPO₄ (lithium nickel phosphate, “LNP”), the gas stream can be an inert and/or an oxidizing gas. That is, the gas stream can be a gas mixture comprising an inert gas, and/or an oxygen-containing gas such as air or pure oxygen. The concentration of the oxygen-containing gas can be similar to that disclosed above with reference to step 207. Alternatively, in other embodiments in which the replenished electrode active material includes LiFePO₄ (lithium iron phosphate. “LFP”). LiMnPO₄ (lithium manganese phosphate. “LMP”). LiMn₁₋ₓFeₓPO₄ (lithium manganese iron phosphate. “LMFP”), and Li₄Ti₅O₁₂ (lithium titanate, “LTO”), the gas stream can be an inert and/or a reducing. That is, the gas stream can be a gas mixture comprising an inert gas, and/or a reducing gas such as hydrogen. The concentration of the hydrogen gas can be similar to that disclosed above with reference to step 207.

In some embodiments, the second period of time Δt₂ can be at least about 0.1 h, at least about 0.2 h, at least about 0.5 h, at least about 0.7 h, at least about 1.0 h, at least about 1.5 h, at least about 2.0 h, at least about 2.5 h, at least about 3.0 h, at least about 4.0 h, at least about 5.0 h, at least about 6.0 h, at least about 7.0 h, at least about 8.0 h, at least about 9.0 h, at least about 10.0 h, at least about 11.0 h, at least about 12.0 h, at least about 13.0 h, at least about 14.0 h, at least about 15.0 h, or at least about 20.0 h, inclusive of all ranges therebetween. In some embodiments, the second period of time Δt₂ can be no more than about 20 h, no more than about 15 h, no more than about 14 h, no more than about 13 h, no more than about 12 h, no more than about 11 h, no more than about 10 h, no more than about 9 h, no more than about 8 h, no more than about 7 h, no more than about 6 h, no more than about 5 h, no more than about 4 h, no more than about 3.0 h no more than about 2.8 h no more than about 2.6 h, no more than about 2.4 h no more than about 2.2 h, no more than about 2.0 h, no more than about 1.8 h, no more than about 1.6 h, no more than about 1.4 h, no more than about 1.2 h, no more than about 1.0 h, no more than about 0.8 h, no more than about 0.6 h, no more than about 0.4 h, or no more than about 0.2 h, inclusive of all ranges therebetween,

In some embodiments, the gas stream used at step 208 can be flowed at a flow rate similar to the flow rates disclosed above with respect to the step 206 and 207 (e.g., a flow rate in the range of 10 to 300 mL/min).

In some embodiments, the second temperature T₂ can be at least about 500° C., at least about 550° C., at least about 600° C., at least about 650° C., at least about 700° C., at least about 750° C.), at least about 800° C., at least about 850° C., at least about 900° C., at least about 950° C., or at least about 1,000° C., inclusive of all ranges therebetween. In some embodiments, the second temperature T₂ can be no more than about 1,000° C., no more than about 950° C., no more than about 900° C., no more than about 850° C., no more than about 840° C., no more than about 800° C. no more than about 760° C., no more than about 720° C., no more than about 680° C., no more than about 640° C.), no more than about 600° C., no more than about 560° C., no more than about 520° C., or no more than about 500° C., inclusive of all ranges therebetween. Combinations of the above-referenced ranges for the second temperature T₂ are also possible (e.g., at least about 650° C., and less than about 750° C., at least about 680° C., and less than about 720° C., or in a range between about 600° C. and about 1,000° C., inclusive).

At step 209, the relithiation process 200 includes cooling the replenished electrode active material from the second temperature T₂ to ambient temperature T_{A} at a cooling rate R₃ flowing a gas stream. In some embodiments, the gas stream flowed during cooling of the replenished electrode active material from the second temperature T₂ to the ambient temperature T_{A} can be substantially the same as the gas stream flowed when the replenished electrode active material is kept at ambient temperature T_{A}, at the first temperature T₁, and/or at the second temperature T₂. In other embodiments, the gas stream flowed during cooling of the replenished electrode active material from the second temperature T₂ to ambient temperature T_{A} can be different from the gas stream flowed when the replenished electrode active material is kept at ambient temperature T_{A}, at the first temperature T₁, and/or at the second temperature T₂.

In some embodiments the first heating rate R₁, the second heating rate R₂, and the cooling rate Ra can be at least about 0.5° C./min. at least about 1.0° C./min, at least about 1.5° C./min. at least about 2.0° C./min. at least about 2.5° C./min. at least about 3.0° C./min. at least about 3.5° C./min. at least about 4.0° C./min. at least about 4.5° C./min. at least about 5.0° C./min, at least about 5.5° C./min. at least about 6.0° C./min. at least about 6.5° C./min. at least about 7.0° C./min. at least about 7.5° C./min. at least about 8.0° C./min. at least about 8.5° C./min. at least about 9.0° C./min, at least about 9.5° C./min. or at least about 10° C./min, inclusive of all ranges therebetween. In some embodiments the first heating rate R₁, the second heating rate R₂, and the cooling rate R₃ can be no more than 10° C./min. no more than 9.0° C./min, no more than 8.0° C./min, no more than 7.0° C./min. no more than 6.0° C./min. no more than 5.0° C./min. no more than 4.0° C./min. no more than 3.0° C./min. no more than 2.0° C./min. no more than 1° C./min. or no more than 0.5° C./min. inclusive of all ranges therebetween. Combinations of the above-referenced ranges for the first heating rate R₁, the second heating rate R₂, and the cooling rate R₃ are also possible (e.g., at least about 1° C./min. and less than about 3° C./min, or at least about 4.5° C./min, and less than about 5.5° C./min).

Methods described herein can also be applied to any electrode materials (i.e., non-depleted, stoichiometric, or substantially stoichiometric), such as scrap electrode materials from an electrode manufacturing process. Such scrap materials may not be “depleted.” but nevertheless may be subjected to one or more of: rinsing, separation, reconstitution/remediation, heat treatment, such that it can be incorporated into a fresh electrochemical cell.

While various embodiments of the system, methods and devices have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. Furthermore, one or more steps can be repeated within a given process. The embodiments have been particularly shown and described, but it will be understood that various changes in form and details may be made.

1. A method for the regeneration of an electrode active material included in a depleted electrode material, the method comprising:
obtaining an electrode active material:
mixing an additive with the electrode active material to produce a replenished electrode active material:
homogenizing the replenished electrode active material; and
exposing the replenished electrode active material to a heat process including:
heating the replenished electrode active material to a first temperature, flowing a gas stream, and holding the replenished electrode active material at the first temperature for a first period of time;
heating the replenished electrode active material to a second temperature, flowing the gas stream, and holding the replenished electrode active material at the second temperature for a second period of time; and
cooling the replenished electrode active material from the second temperature to ambient temperature flowing the gas stream.

2. The method of claim 1, wherein the depleted electrode material is a semisolid cathode or conventional solid electrode.

3. The method of claim 1, wherein the electrode active material includes at least one of LiCoO₂ (“LCO”), Li(Ni, Mn, Co)O₂ (“NMC”), LiNi_{0.8}Co_{0.15}Al_{0.05}O₂ (“NCA”), LiMn₂O₄ (“LMO”), LiCoPO₄ (“LCP”), or LiNiPO₄ (“LNP”).

4. The method of claim 1, wherein the electrode active material includes at least one of LiFePO₄ (“LFP”), LiMnPO₄ (“LMP”), LiMn₁₋ₓFeₓPO₄ (“LMFP”), or Li₄Ti₅O₁₂ (“LTO”).

5. The method of claim 1, wherein the additive is a lithium-containing additive.

6. The method of claim 5, wherein the additive includes at least one of a lithium carbonate, a lithium hydroxide, a lithium nitrate, a lithium sulfate, Fe₃(PO₄)₂·8H₂O, Fe(CH₃CO₂)₂, FeC₂O₄·2H₂O, Fe₃(NO₃)₃, FeCl₃, Fe₂O₃, NiO, NiSO₄·6H₂O, NiCl₂·6H₂O, Ni(NO₃)₂·6H₂O, Ni(CH₃CO₂)₂·4H₂O, Ni(OH)₂, MnO₂, MnSO₄·H₂O, MnCl₂·4H₂O, Mn(NO₂)₂·4H₂O, Mn(CH₃CO₂)₂, Mn(OH)₂, CoO, Co₂O₃, Co₃O₄, CoSO₄·7H₂O, CoCl₂·6H₂O, Co(NO₃)₂·6H₂O, Co(CH₃CO₂)₂·4H₂O, or Co(OH)₂.

7. The method of claim 5, wherein the additive is mixed in an amount sufficient to replenish at least about 5% lithium lost from the electrode active material.

8. The method of claim 1, wherein the first temperature is between about 150° C. and about 550° C.

9. The method of claim 8, wherein the first temperature is one of about 250° C. or about 450° C.

10. The method of claim 8, wherein the first period of time is between about 0 hour and about 7 hours.

11. The method of claim 8, wherein the first period of time is one of about 0 hours, about 3 hours, or about 5 hours.

12. The method of claim 1 wherein the heating to the first temperature is done at a first heating rate, the first heating rate being about 5° C./min.

13. The method of claim 1, wherein the second temperature is between about 600° C. and about 1,000° C.

14. The method of claim 13, wherein the second temperature is about 700° C.

15. The method of claim 13, wherein the second temperature is between a range of about 750° C. and about 850° C.

16. The method of claim 13, wherein the second period of time is between about 0.5 hours and about 20 hours.

17. The method of claim 13, wherein the second period of time is one of about 1 hour or about 15 hours.

18. The method of claim 1 wherein the heating to the second temperature is done at a second heating rate, the second heating rate being about 5° C./min.

19. The method of claim 1, wherein the cooling the replenished electrode active material is done at a cooling rate of about 5° C./min.

20. The method of claim 1, wherein the flowing a gas stream includes flowing 99.999% nitrogen, at a flow rate in a range of about 0 ml/min to about 100 ml/min.

21. The method of claim 1, wherein the flowing a gas stream includes flowing at least one of oxygen or dry air.

22. A method, comprising:
mixing one or more additives with a used electrode active material to produce a replenished electrode active material;
heating the replenished electrode active material to a first temperature while exposed to a first gas;
holding the replenished electrode active material at the first temperature for a first period of time;
heating the replenished electrode active material to a second temperature while exposed to a second gas;
holding the replenished electrode active material at the second temperature for a second period of time; and
cooling the replenished electrode active material from the second temperature to ambient temperature while exposed to the second gas.

23. The method of claim 22, wherein the first gas and the second gas include the same gas.

24. The method of claim 22, wherein the first gas and the second gas include at least one of nitrogen, oxygen, or dry air.

25. The method of claim 22, wherein the used electroactive material is obtained from a depleted semisolid electrode, or a conventional solid electrode.

26. The method of claim 22, wherein the used electrode active material includes at least one of LiCoO₂ (“LCO”), Li(Ni, Mn, Co)O₂ (“NMC”), LiNi_{0.8}Co_{0.15}Al_{0.05}O₂ (“NCA”), LiMn₂O₄ (“LMO”), LiCoPO₄ (“LCP”), or LiNiPO₄ (“LNP”).

27. The method of claim 22, wherein the used electrode active material includes at least one of LifePO₄ (“LFP”), LiMnPO₄ (“LMP”), LiMn₁₋ₓFeₓPO₄ (“LMFP”), or Li₄Ti₅O₁₂ (“LTO”).

28. The method of claim 22, wherein the additive is a lithium-containing additive.

29. The method of claim 22, wherein the additive includes at least one of a lithium carbonate, a lithium hydroxide, a lithium nitrate, a lithium sulfate, Fe₃(PO₄)₂·8H₂O, Fe(CH₃CO₂)₂, FeC₂O₄·2H₂O, Fe₃(NO₃)₃, FeCl₃, Fe₂O₃, NiO, NiSO₄·6H₂O, NiCl₂·6H₂O, Ni(NO₃)₂·6H₂O, Ni(CH₃CO₂)₂·4H₂O, Ni(OH)₂, MnO₂, MnSO₄·H₂O, MnCl₂·4H₂O, Mn(NO₂)₂·4H₂O, Mn(CH₃CO₂)₂, Mn(OH)₂, CoO, Co₂O₃, Co₃O₄, CoSO₄·7H₂O, CoCl₂·6H₂O, Co(NO₃)₂·6H₂O, Co(CH₃CO₂)₂·4H₂O, or Co(OH)₂.

30. The method of claim 22, wherein the first temperature is between about 150° C. and about 550° C.

31. The method of claim 30, wherein the first period of time is between about 0 hour and about 7 hours.

32. The method of claim 22 wherein the heating to the first temperature is done at a first heating rate, the first heating rate being about 5° C./min.

33. The method of claim 22, wherein the second temperature is between about 600° C. and about 1,000° C.

34. The method of claim 33, wherein the second period of time is between about 0.5 hours and about 20 hours.

35. The method of claim 22, wherein the heating to the second temperature is done at a second heating rate, the second heating rate being about 5° C./min.

36. The method of claim 22, wherein the cooling the replenished electrode active material is done at a cooling rate of about 5° C./min.

37. A method for replenishing an electrode active material included in a depleted electrode material, the method comprising:
mixing an additive with the electrode active material to produce a mixture;
exposing the mixture to a gas flow for a first period of time at ambient temperature:
heating the mixture to a replenishing temperature while exposed to the gas flow:
holding the mixture at the replenishing temperature for a second period of time while exposed to the gas flow; and
cooling the mixture to the ambient temperature while exposed to the gas flow to obtain a replenished electrode active material.

38. The method of claim 37, wherein the replenishing temperature is in a range of between about 600° C. and about 1,000° C.

39. The method of claim 38, wherein the gas flow includes a flow of at least one of oxygen or dry air.

40. The method of claim 37, further comprising:
prior to heating the mixture to the replenishing temperature, heating the mixture to an intermediate temperature while exposed to the gas flow, the intermediate temperature being less than the replenishing temperature; and
holding the mixture at the intermediate temperature for a third period of time while exposed to the gas flow.

41. The method of claim 40, wherein the replenishing temperature is between about 150° C. and about 550° C.

42. The method of claim 41, wherein the gas flow includes a flow of at least one of nitrogen, oxygen, or dry air.

43. The method of claim 37, wherein the electroactive material is obtained from a depleted semisolid electrode, or a conventional solid electrode.

44. The method of claim 37, wherein the electrode active material includes at least one of LiCoO₂ (“LCO”), Li(Ni, Mn, Co)O₂ (“NMC”), LiNi_{0.8}Co_{0.15}Al_{0.05}O₂(“NCA”), LiMn₂O₄ (“LMO”), LiCoPO₄ (“LCP”), or LiNiPO₄ (“LNP”).

45. The method of claim 37, wherein the electrode active material includes at least one of LiFePO₄ (“LFP”), LiMnPO₄ (“LMP”), LiMn₁₋ₓFeₓPO₄ (“LMFP”), or Li₄Ti₅O₁₂ (“LTO”).

46. The method of claim 37, wherein the additive includes at least one of a lithium carbonate, a lithium hydroxide, a lithium nitrate, a lithium sulfate, Fe₃(PO₄)₂·8H₂O, Fe(CH₃CO₂)₂, FeC₂O₄·2H₂O, Fe₃(NO₃)₃, FeCl₃, Fe₂O₃, NiO, NiSO₄·6H₂O, NiCl₂·6H₂O, Ni(NO₃)₂·6H₂O, Ni(CH₃CO₂)₂·4H₂O, Ni(OH)₂, MnO₂, MnSO₄·H₂O, MnCl₂·4H₂O, Mn(NO₂)₂·4H₂O, Mn(CH₃CO₂)₂, Mn(OH)₂, CoO, Co₂O₃, Co₃O₄, CoSO₄.7H₂O, CoCl₂·6H₂O, Co(NO₃)₂·6H₂O, Co(CH₃CO₂)₂·4H₂O, or Co(OH)₂.
